(19) United States
(12) Patent Application Publication
(10) Pub. No.: US 2018/0369863 A1
(43) Pub. Date: Dec. 27, 2018

(54) VIBRATION DEVICE, VIBRATION DEVICE MODULE, ELECTRONIC DEVICE, AND VEHICLE

(71) Applicant: Seiko Epson Corporation, Tokyo (JP)

(72) Inventors: Kei KANEMOTO, Fujimi (JP); Takayuki KIKUCHI, Chino (JP)

(21) Appl. No.: 16/016,792

(22) Filed: Jun. 25, 2018

(30) Foreign Application Priority Data
Jun. 26, 2017 (JP) 2017-124207

(51) Int. Cl. B06B 1/02; G01P 3/483; G01P 15/125

(52) U.S. Cl. CPC B06B 1/0292; B06B 1/0207; B06B 2201/70; G01P 15/125; G01P 3/483

(57) ABSTRACT

A vibration device includes a substrate that contains movable ions, an element unit that has a movable portion which is displaceable from the substrate, and a conductor layer that is disposed on a side of the substrate which is opposite to the element unit. When a potential of the movable portion is set to E1 and a potential of the conductor layer is set to E2, |E1−E2|<|E1| is satisfied. In a plan view obtained in a direction where the conductor layer, the substrate, and the element unit are juxtaposed with one another, the conductor layer overlaps at least a portion of the movable portion.

### CROSS-REFERENCE TO RELATED APPLICATION

This nonprovisional application claims the benefit of Japanese Patent Application No. 2017-124207 filed Jun. 26, 2017, the entire disclosure of which is expressly incorporated herein by reference.

### BACKGROUND

### 1. Technical Field

The present invention relates to a vibration device, a vibration device module, an electronic device, and a vehicle.

### 2. Related Art

For example, an acceleration sensor disclosed in JP-A-2000-275272 includes a glass substrate and a silicon substrate bonded to an upper surface of the glass substrate. The silicon substrate includes a sealing portion bonded to the glass substrate, a movable electrode disposed to face the glass substrate at an interval therebetween, and a beam which connects the movable electrode and the sealing portion to each other so that the movable electrode can be displaced from the glass substrate.

A fixed electrode is disposed in a portion facing the movable electrode, on a surface of the glass substrate on the silicon substrate side. Capacitance is generated between the movable electrode and the fixed electrode. When acceleration is added thereto, a gap between the movable electrode and the fixed electrode is displaced since the movable electrode is displaced from the glass substrate. In response to this displacement, the capacitance generated between the movable electrode and the fixed electrode is changed. Therefore, the acceleration sensor disclosed in JP-A-2000-275272 can detect acceleration received based on the change in the capacitance.

Here, JP-A-2000-275272 discloses that Pyrex glass (registered trademark) is used as the glass substrate. Therefore, the glass substrate contains movable ions such as sodium ions (Na⁺).

However, for example, due to a voltage applied to the fixed electrode, the movable ions contained in the glass substrate is moved, thereby causing a possibility that the surface of the glass substrate on the silicon substrate side may be charged. Electrostatic attraction is generated between the glass substrate and the beam due to the charging of the surface of the glass substrate on the silicon substrate side. Due to the electrostatic attraction, the movable electrode together with the beam is attracted to the glass substrate side. Consequently, the movable electrode is displaced from the glass substrate even though the acceleration is not added thereto. Therefore, there is a problem in that a drift is caused in an output signal from the acceleration sensor.

### SUMMARY

An advantage of some aspects of the invention is to provide a vibration device, a vibration device module, an electronic device, and a vehicle, which can minimize an output drift.

The advantage can be achieved by the following configurations.

A vibration device according to an aspect of the invention includes a substrate that contains movable ions, an element unit that has a movable portion which is displaceable from the substrate, and a conductor layer that is disposed on a side of the substrate which is opposite to the element unit side. When a potential of the movable portion is set to E1 and a potential of the conductor layer is set to E2, |E1−E2|<|E1| is satisfied.

In this manner, it is possible to minimize the movement of the movable ions inside the substrate, and it is possible to minimize possibilities that the movable portion is displaced due to electrostatic attraction generated between the substrate and the movable portion. Therefore, it is possible to obtain the vibration device which can minimize an output drift.

In the vibration device according to the aspect of the invention, it is preferable that E1=E2 is satisfied.

In this manner, it is possible to more effectively minimize the output drift.

In the vibration device according to the aspect of the invention, it is preferable that in a plan view obtained in a direction where the conductor layer, the substrate, and the element unit are juxtaposed with one another, the conductor layer is disposed so as to overlap at least a portion of the movable portion.

In this manner, it is possible to more effectively minimize the output drift.

A vibration device according to another aspect of the invention includes a substrate that contains movable ions, an element unit that has a first movable portion and a second movable portion which are displaceable from the substrate, and a conductor layer that is disposed on a side of the substrate which is opposite to the element unit side. In a plan view obtained in a direction where the conductor layer, the substrate, and the element unit are juxtaposed with one another, the conductor layer has a first conductor layer that is disposed so as to overlap at least a portion of the first movable portion, and a second conductor layer that is disposed so as to overlap at least a portion of the second movable portion. When a potential of the first movable portion is set to E1′ and a potential of the first conductor layer is set to E2′, |E1′−E2′|<|E1′| is satisfied. When a potential of the second movable portion is set to E1″ and a potential of the second conductor layer is set to E2″, |E1″−E2″|<|E1″| is satisfied.

In this manner, it is possible to minimize the movement of the movable ions inside the substrate, and it is possible to minimize possibilities that the first and second movable portions are displaced due to the electrostatic attraction generated between the substrate and the first and second movable portions. Therefore, it is possible to obtain the vibration device which can minimize the output drift.

In the vibration device according to the aspect of the invention, it is preferable that the element unit is capable of detecting angular velocity in the first movable portion, and that the second movable portion is capable of detecting acceleration.

In this manner, it is possible to achieve the highly convenient vibration device.

In the vibration device according to the aspect of the invention, it is preferable that the vibration device further includes a fixed detection electrode disposed in the substrate so as to detect displacement of the movable portion with respect to the substrate.

In this manner, the vibration device is applicable as a physical quantity sensor for detecting a physical quantity such as angular velocity.

A vibration device module according to another aspect of the invention includes the vibration device according to the aspect of the invention, and a package that accommodates the vibration device.

In this manner, the vibration device can be protected using the package. In addition, it is possible to obtain an advantageous effect of the vibration device according to the aspect of the invention, and it is possible to obtain the highly reliable vibration device module.

In the vibration device module according to the aspect of the invention, it is preferable that the vibration device module has a circuit element which is accommodated in the package, and which is electrically connected to the vibration device.

In this manner, the circuit element can be protected using the package.

In the vibration device module according to the aspect of the invention, it is preferable that the vibration device is fixed to the package via the circuit element.

In this manner, internal stress of the package is less likely to be transmitted to the vibration device.

An electronic device according to another aspect of the invention includes the vibration device according to the aspect of the invention.

In this manner, it is possible to obtain an advantageous effect of the vibration device according to the aspect of the invention, and it is possible to obtain the highly reliable electronic device.

A vehicle according to another aspect of the invention includes the vibration device according to the aspect of the invention.

In this manner, it is possible to obtain an advantageous effect of the vibration device according to the aspect of the invention, and it is possible to obtain the highly reliable vehicle.

### BRIEF DESCRIPTION OF THE DRAWINGS

The invention will be described with reference to the accompanying drawings, wherein like numbers reference like elements.

FIG. 1 is a plan view illustrating a vibration device according to a first embodiment of the invention.

FIG. 2 is a sectional view taken along line A-A in FIG. 1.

FIG. 3 illustrates a voltage applied to the vibration device illustrated in FIG. 1.

FIG. 4 is a plan view of a vibration device according to a second embodiment of the invention.

FIG. 5 is a sectional view taken along line B-B in FIG. 4.

FIG. 6 illustrates a voltage applied to the vibration device illustrated in FIG. 4.

FIG. 7 is a sectional view illustrating a vibration device module according to a third embodiment of the invention.

FIG. 8 is a sectional view illustrating a modification example of the vibration device module illustrated in FIG. 7.

FIG. 9 is a sectional view illustrating a vibration device module according to a fourth embodiment of the invention.

FIG. 10 is a sectional view illustrating a vibration device module according to a fifth embodiment of the invention.

FIG. 11 is a perspective view illustrating an electronic device according to a sixth embodiment of the invention.

FIG. 12 is a perspective view illustrating an electronic device according to a seventh embodiment of the invention.

FIG. 13 is a perspective view illustrating an electronic device according to an eighth embodiment of the invention.

FIG. 14 is a perspective view illustrating a vehicle according to a ninth embodiment of the invention.

### DESCRIPTION OF EXEMPLARY EMBODIMENTS

Hereinafter, a vibration device, a vibration device module, an electronic device, and a vehicle according to the invention will be described in detail with reference to the accompanying drawings.

### First Embodiment

First, the vibration device according to a first embodiment of the invention will be described.

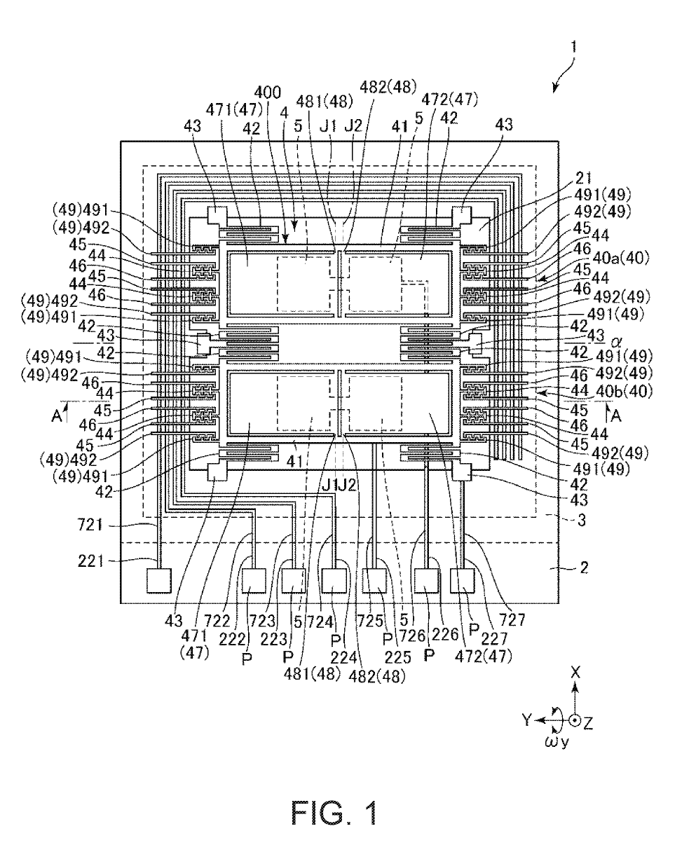

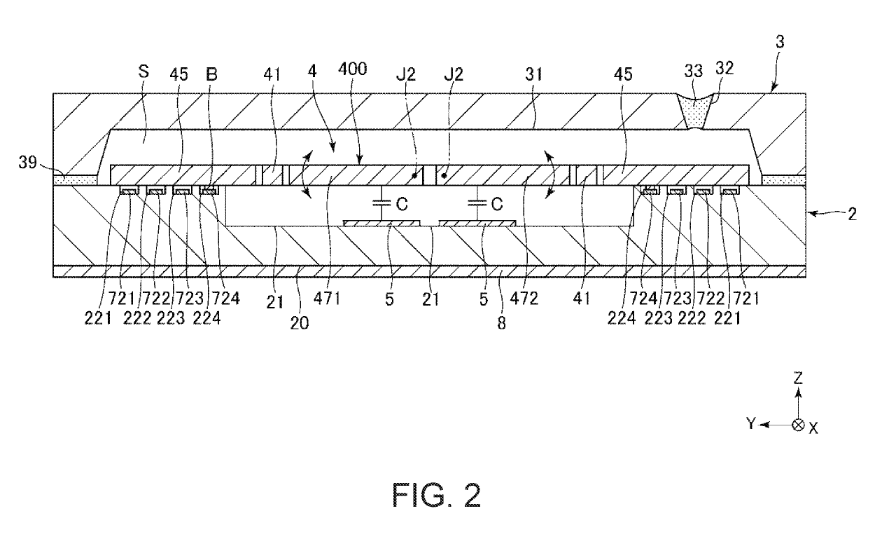

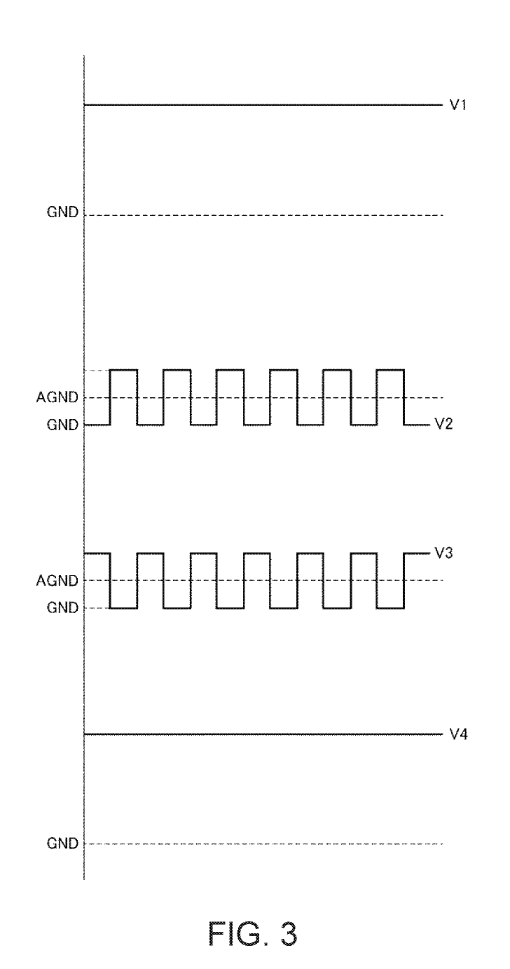

FIG. 1 is a plan view illustrating a vibration device according to the first embodiment of the invention. FIG. 2 is a sectional view taken along line A-A in FIG. 1. FIG. 3 illustrates a voltage applied to the vibration device illustrated in FIG. 1. Hereinafter, for the sake of convenience of description, an outward side of the drawing in FIG. 1 and an upper side in FIG. 2 will be referred to as “upward”, and an inward side of the drawing in FIG. 1 and a lower side in FIG. 2 will be referred to as “downward”. In each drawing, an X-axis, a Y-axis, and a Z-axis are illustrated as three axes orthogonal to each other. Hereinafter, a direction parallel to the X-axis will be referred to as an “X-axis direction”, a direction parallel to the Y-axis will be referred to as a “Y-axis direction”, and a direction parallel to the Z-axis will be referred to as a “Z-axis direction”. In addition, an arrow tip side of each axis will be referred to as a “positive side”, and a side opposite thereto will be referred to as a “negative side”.

A vibration device 1 illustrated in FIGS. 1 and 2 is an angular velocity sensor capable of detecting angular velocity ωy around the Y-axis. The vibration device 1 has a substrate 2, a lid body 3, an element unit 4, and a conductor layer 8.

As illustrated in FIG. 1, the substrate 2 has a plate shape having a rectangular shape in a plan view shape. The substrate 2 has a recess portion 21 which is open on an upper surface side. The recess portion 21 functions as an escape portion for minimizing contact between the element unit 4 and the substrate 2. The element unit 4 is bonded to the upper surface of the substrate 2. The substrate 2 has grooves 221, 222, 223, 224, 225, 226, and 227 which are open on the upper surface side.

For example, as this substrate 2, it is possible to use a glass substrate configured to include a glass material (for example, borosilicate glass such as Tempax glass (registered trademark) and Pyrex glass (registered trademark)) containing movable ions (alkali metal ions, hereinafter represented by Na⁺) such as sodium ions (Na⁺) and lithium ions (Li⁺). In this manner, for example, as will be described later, the substrate 2 and the element unit 4 can be anodically bonded to each other, and both of these can be firmly bonded to each other. The substrate 2 having light transmittance can be obtained. Accordingly, a state of the element unit 4 can be visibly recognized from the outside of the vibration device 1 via the substrate 2. A configuration material of the substrate 2 is not limited to the glass material as long as the material has the movable ions.

As illustrated in FIG. 1, wires 721, 722, 723, 724, 725, 726, and 727 are respectively disposed in grooves 221, 222, 223, 224, 225, 226, and 227. Each one end portion of the wires 721, 722, 723, 724, 725, 726, and 727 is exposed outward of the lid body 3, and functions as an electrode pad P for electrical connection with an external device.

Four fixed detection electrodes 5 forming capacitance C with the element unit 4 are disposed on a bottom surface of the recess portion 21. As illustrated in FIG. 2, a conductor layer 8 is disposed on a lower surface of the substrate 2. The conductor layer 8 is disposed so as to spread over an entire region of the lower surface 20 of the substrate 2. However, a method of disposing the conductor layer 8 is not particularly limited. For example, the conductor layer 8 may be disposed in only a portion of the lower surface 20 of the substrate 2, instead of the entire region of the lower surface 20 of the substrate 2. That is, a portion of the lower surface 20 of the substrate 2 may be exposed from the conductor layer 8. Other layers such as an insulation layer may be interposed between the substrate 2 and the conductor layer 8.

Configuration materials of the wires 721, 722, 723, 724, 725, 726, and 727, the fixed detection electrode 5, and the conductor layer 8 are not particularly limited as long as the materials respectively have conductivity. For example, the materials include metal materials such as gold (Au), silver (Ag), platinum (Pt), palladium (Pd), iridium (Ir), copper (Cu), aluminum (Al), nickel (Ni), titanium (Ti), and tungsten (W), alloys containing these metal materials, or oxide-based transparent conductive materials such as indium tin oxide (ITO) indium zinc oxide (IZO), ZnO, and IGZO. One type or a combination of two or more types of the materials can be used (for example, as a stacked body of two or more layers).

As illustrated in FIG. 1, the lid body 3 has a plate shape having a rectangular shape in a plan view. As illustrated in FIG. 2, the lid body 3 has a recess portion 31 which is open on a lower surface side (substrate 2 side). This lid body 3 is bonded to the upper surface of the substrate 2 so as to accommodate the element unit 4 inside the recess portion 31. An accommodation space S for internally accommodating the element unit 4 is formed by the lid body 3 and the substrate 2.

As illustrated in FIG. 2, the lid body 3 has a communication hole 32 which allows the inside the accommodation space S to communicate with the outside. Through this communication hole 32, the accommodation space S can be provided with a desired atmosphere. A sealing member 33 is disposed inside the communication hole 32, and the communication hole 32 is hermetically sealed with the sealing member 33. The accommodation space S is preferably in a reduced pressure state, particularly in a vacuum state. In this manner, viscous resistance decreases, and the element unit 4 can be efficiently vibrated (driven).

A material of the sealing member 33 is not particularly limited as long as the communication hole 32 can be sealed. For example, it is possible to use various alloys such as a gold (Au)/tin (Sn) based alloy, a gold (Au)/germanium (Ge) based alloy, and a gold (Au)/aluminum (Al) based alloy, or glass materials such as low melting point glass.

For example, as this lid body 3, it is possible to use a conductive silicon substrate doped with impurities, particularly such as phosphorus (P) and boron (B). However, the lid body 3 is not particularly limited. For example, a glass substrate or a ceramic substrate may be used. A method of bonding the substrate 2 and the lid body 3 to each other is not particularly limited, and may be appropriately selected depending on the material of the substrate 2 and the lid body 3. For example, the method includes anodic bonding, activation bonding in which bonding surfaces activated by plasma irradiation are bonded to each other, bonding by using a bonding material such as a glass frit, and diffusion bonding in which metal films formed on the upper surface of the substrate 2 and the lower surface of the lid body 3 are bonded to each other.

In the embodiment, as illustrated in FIG. 2, the substrate 2 and the lid body 3 are bonded to each other via a glass frit 39 (low melting point glass) serving as an example of the bonding material. In a state where the substrate 2 and the lid body 3 overlap each other, although the inside and the outside of the accommodation space S communicate with each other via the grooves 221, 222, 223, 224, 225, 226, and 227, the glass frit 39 is used. In this manner, the substrate 2 and the lid body 3 can be bonded to each other, and the grooves 221, 222, 223, 224, 225, 226, and 227 can be sealed with the glass frit 39. Therefore, the accommodation space S can be more easily and hermetically sealed. In a case where the substrate 2 and the lid body 3 are bonded to each other by means of anodic bonding (bonding method in which the grooves 221, 222, 223, 224, 225, 226, and 227 cannot be sealed), for example, the grooves 221, 222, 223, 224, 225, 226, and 227 can be closed by a SiO₂ film formed using a CVD method of using tetraethyl orthosilicate (TEOS).

As illustrated in FIG. 1, the element unit 4 is disposed in the accommodation space S, and is bonded to the upper surface of the substrate 2. The element unit 4 has two structures 40 (40a and 40b). For example, this element unit 4 can be formed using the following method. A conductive silicon substrate doped with impurities such as phosphorus and boron is patterned using a dry etching method (particularly, the Bosch method).

The two structures 40a and 40b are juxtaposed with each other in the X-axis direction, and are symmetrical with respect to a virtual straight line a extending along the Y-axis. The structures 40a and 40b respectively have a drive portion 41, a drive spring 42, a fixed portion 43, a movable drive electrode 44, fixed drive electrodes 45 and 46, a detecting flap plate 47, a beam 48, and a drive monitor electrode 49. The detecting flap plate 47 has a first flap plate 471 and a second flap plate 472. The beam 48 has a first beam 481 and a second beam 482. The drive monitor electrode 49 has a movable monitor electrode 491 and a fixed monitor electrode 492. Hereinafter, a structure including the drive portion 41, the drive spring 42, the fixed portion 43, the movable drive electrode 44, the detecting flap plate 47, the beam 48, and the movable monitor electrode 491 which belong to the structures 40a and 40b will be referred to as a “movable portion 400”.

The drive portion 41 is a rectangular frame. One end portion of the drive spring 42 is connected to each of four corners of the drive portion 41. The drive spring 42 has elasticity in the X-axis direction, and supports the drive portion 41 so as to be displaceable in the X-axis direction. This drive spring 42 has a serpentine shape, and extends in the X-axis direction while reciprocating in the Y-axis direction. The other end of the drive spring 42 is connected to the fixed portion 43, and the fixed portion 43 is bonded to the upper surface of the substrate 2.

In this manner, the drive portion 41 and the drive spring 42 are supported in a floating state from the substrate 2. A method of bonding the fixed portion 43 and the substrate 2 to each other is not particularly limited. However, for example, anodic bonding can be used. At least one of the plurality of fixed portions 43 is electrically connected to the wire 727 via a conductive bump (not illustrated). However, a method of electrically connecting the fixed portion 43 and the wire 727 to each other is not particularly limited, and both of these may be in direct contact without the conductive bump interposed therebetween.

The movable drive electrode 44 is disposed in the drive portion 41. In the embodiment, total four movable drive electrodes 44 are disposed in such a manner that two are located on the positive side in the Y-axis direction of the drive portion 41 and two are located on the negative side in the Y-axis direction. The movable drive electrode 44 has a comb-tooth shape including a support portion extending from the drive portion 41 in the Y-axis direction and a plurality of electrode fingers extending from the support portion to both sides in the X-axis direction. The arrangement and the number of the movable drive electrodes 44 are not particularly limited.

The fixed drive electrodes 45 and 46 are bonded to the substrate 2. One of the movable drive electrodes 44 is located between a pair of the fixed drive electrodes 45 and 46. Each of the fixed drive electrodes 45 and 46 has a comb-tooth shape including a support portion extending in the Y-axis direction and a plurality of electrode fingers extending from the support portion to one side (movable drive electrode 44 side) in the X-axis direction.

Each fixed drive electrode 45 is electrically connected to the wire 724 via a conductive bump B (refer to FIG. 2), and each fixed drive electrode 46 is electrically connected to the wire 723 via a conductive bump (not illustrated). However, a method of electrically connecting each fixed drive electrodes 45 and the wire 724 to each other and a method of electrically connecting each fixed drive electrodes 46 and the wire 723 to each other are not particularly limited, and both of these may be in direct contact with each other without the conductive bump interposed therebetween.

According to this configuration, for example, a voltage V1 illustrated in FIG. 3 is applied to the movable portion 400 via the wire 727, and a voltage V2 illustrated in FIG. 3 is applied via the wire 724 to each fixed drive electrodes 45. A voltage V3 illustrated in FIG. 3 is applied to each fixed drive electrode 46 via the wire 723. The voltage V1 is higher than GND, and a magnitude (potential) thereof is chronologically and substantially constant. The voltages V2 and V3 respectively form a rectangular wave whose magnitude (potential) is periodically changed around AGND (for example, 0.9 V).

These voltages V1, V2, and V3 are applied to the vibration device 1. Accordingly, electrostatic attraction is generated between the movable drive electrode 44 and the fixed drive electrodes 45 and 46. Each drive portion 41 vibrates in the X-axis direction while elastically deforming the drive spring 42 in the X-axis direction. Here, in the structure 40a and the structure 40b, the arrangement of the fixed drive electrodes 45 and 46 is symmetrical with respect to the virtual straight line U. Therefore, the two drive portions 41 vibrate in opposite phases in the X-axis direction so as to be closer to or farther away from each other. In this manner, the vibration of the two drive portions 41 can be canceled, and vibration leakage can be minimized. Hereinafter, this vibration mode will be referred to as a “drive vibration mode”. If the drive portion 41 can be vibrated in the drive vibration mode, the voltages V1, V2, and V3 are not particularly limited.

As described above, the embodiment employs a method of vibrating the drive portion 41 in the X-axis direction by using the electrostatic attraction (electrostatic drive method). However, the method of vibrating the drive portion 41 in the X-axis direction is not particularly limited. A piezoelectric drive method, an electromagnetic drive method using the Lorentz force of a magnetic field, can also be employed.

The drive monitor electrode 49 has a movable monitor electrode 491 and a fixed monitor electrode 492 which form a pair and form capacitance therebetween. The movable monitor electrode 491 is disposed in the drive portion 41. According to the embodiment, in total four movable monitor electrodes 491, two are disposed on the positive side in the X-axis direction of the drive portion 41, and two are disposed on the negative side in the X-axis direction. These movable monitor electrodes 491 respectively have a comb-tooth shape including a support portion extending from the drive portion 41 in the Y-axis direction and a plurality of electrode fingers extending from the support portion to one side (fixed monitor electrode 492 side) in the X-axis direction. On the other hand, the fixed monitor electrode 492 is bonded to the substrate 2, and a plurality of the fixed monitor electrodes 492 are disposed so as to face the movable monitor electrode 491. These respective fixed monitor electrodes 492 have a com-tooth shape including a support portion extending in the Y-axis direction and a plurality of electrode fingers extending from the support portion to one side (movable monitor electrode 491 side) in the X-axis direction.

In the four movable monitor electrodes 491 belonging to the structure 40a, the two movable monitor electrodes 491 located on the positive side in the X-axis direction are electrically connected to the wire 722 via a conductive bump (not illustrated). The two movable monitor electrodes 491 located on the negative side in the X-axis direction are electrically connected to the wire 721 via a conductive bump (not illustrated). In the four movable monitor electrodes 491 belonging to the structure 40b, the two movable monitor electrodes 491 located on the negative side in the X-axis direction are electrically connected to the wire 722 via a conductive bump (not illustrated). The two movable monitor electrodes 491 located on the positive side in the X-axis direction are electrically connected to the wire 721 via a conductive bump (not illustrated).

Each fixed monitor electrode 492 is connected to a QV amplifier circuit (not illustrated) via these wires 721 and 722, and has AGND potential (for example, 0.9 V). On the other hand, as described above, the voltage V1 is applied to the movable portion 400 via the wire 721. In this manner, the capacitance is formed between the movable monitor electrode 491 and the fixed monitor electrode 492.

If the element unit 4 is vibrated in a drive vibration mode, a gap between the movable monitor electrode 491 and the fixed monitor electrode 492 is changed due to the displacement of the drive portion 41 in the X-axis direction. Accordingly, the capacitance between the movable monitor electrode 491 and the fixed monitor electrode 492 is changed. Therefore, based on this change in the capacitance, it is possible to monitor a vibrating state of the movable portion 400 (each drive portion 41).

The first and second flap plates 471 and 472 are located inside the drive portion 41, and are juxtaposed with each other in the Y-axis direction. The first and second flap plates 471 and 472 respectively have a rectangular plate shape. The first flap plate 471 is connected to the drive portion 41 via the first beam 481, and the second flap plate 472 is connected to the drive portion 41 via the second beam 482. In a state where the drive portion 41 is driven in the drive vibration mode driving, if the angular velocity ωy around the Y-axis is applied to the vibration device 1, the first and the second flap plates 471 and 472 is the Coriolis force, while the first and second beams 481 and 482 torsionally deform (elastically deform) the first and the second beams 481 and 482, the first and second beams 481 and 482 pivot around pivot shafts J1 and J2 formed by the first and the second beams 481 and 482. Hereinafter, this vibration mode will be referred to as a “detection vibration mode”.

An orientation of the first and second flap plates 471 and 472 is not particularly limited. For example, free ends of the first flap plate 471 and the second flap plate 472 may be disposed to face each other, or the free ends of the second flap plates 471 and 472 may be disposed while being oriented in the same direction. One of the first and second flap plates 471, 472 may be omitted.

As illustrated in FIG. 2, the fixed detection electrodes 5 are respectively disposed in regions (regions overlapping with each other in a plan view in the Z-axis direction) facing the first and second flap plates 471 and 472 of the substrate 2. Capacitance C is formed between the first flap plate 471 and the fixed detection electrode 5 and between the second flap plate 472 and the fixed detection electrode 5.

As illustrated in FIG. 1, the two fixed detection electrodes 5 facing the structure 40a are electrically connected to the wire 726, and the two fixed detection electrodes 5 facing the structure 40b are electrically connected to the wire 725.

If the angular velocity ωy is applied when the two drive portions 41 are vibrated in the above-described drive vibration mode, the detection vibration mode is excited. In this manner, a gap between the first and second flap plates 471 and 472 and the fixed detection electrode 5 is changed, and the capacitance C is changes in response to the change. Therefore, the change amount (differential signal) of the capacitance C is detected, and thus, the angular velocity ωy can be obtained.

In the detection vibration mode, if the gap between the first and second flap plates 471 and 472 and the fixed detection electrode 5 is narrowed in the structure 40a, the gap between the first and second flap plates 471 and 472 and the fixed detection electrode 5 is widened in the structure 40b. Conversely, if the gap between the first and second flap plates 471 and 472 and the fixed detection electrode 5 is widened in the structure 40a, the gap between the first and second flap plates 471 and 472 and the fixed detection electrode 5 is narrowed in the structure 40b. Therefore, noise can be canceled by differentially calculating a first detection signal obtained from the structure 40a and a second detection signal obtained from the structure 40b. In this manner, the angular velocity ωy can be more accurately detected.

Here, when the vibration device 1 is operated, a voltage V4 in FIG. 3 is applied to the conductor layer 8. The magnitude of the voltage V4 is chronologically and substantially constant. Therefore, the conductor layer 8 demonstrates a shielding effect to block or minimize leakage of a signal detected by the vibration device 1 or noise externally applied to the vibration device 1. Accordingly, the vibration device 1 can accurately detect the angular velocity ωy.

In particular, according to the embodiment, the voltage V4 is the same as the voltage V1 applied to the movable portion 400. That is, the voltages V1 and V4 have the same magnitude. In this manner, the conductor layer 8 and the movable portion 400 which are disposed in the substrate 2 therebetween have the same potential. Substantially, there is no potential difference between the lower surface side and the upper surface side of the substrate 2 (An electric field in the thickness direction does not act on the substrate 2), and the movement of the movable ions (Na⁺) inside the substrate 2 is minimized. Therefore, the charging of the bottom surface of the recess portion 21 is minimized.

Here, for example, if the conductor layer 8 is connected to GND (0 V), an electric field acts on the substrate 2 due to the potential difference between the conductor layer 8 and the movable portion 400. In this manner, the movable ions (Na⁺) starts to move inside the substrate 2, and the bottom surface of the recess portion 21 is charged. In this case, an electrostatic attraction is generated between the bottom surface (portion exposed from the fixed detection electrode 5) of the recess portion 21 and the movable portion 400. The electrostatic attraction causes the movable portion 400 to be attracted toward the substrate 2. Although the angular velocity ωy is not applied, the gap between the first and second flap plates 471 and 472 and the fixed detection electrode 5 is changed. As a result, the output drift occurs. In addition, a “sticking” state may occur where the movable portion 400 attracted to the substrate 2 side by the electrostatic attraction sticks to the bottom surface of the recess portion 21. Accordingly, in some cases, the vibration device 1 may not function as an angular velocity sensor.

Therefore, as described above, the voltage V4 which is the same as the voltage V1 is applied to the conductor layer 8, and the charging of the bottom surface of the recess portion 21 is minimized. In this manner, in a state where the angular velocity ωy is not applied, it is possible to minimize the change in the gap between the first and second flap plates 471 and 472 and the fixed detection electrode 5, and it is possible to minimize the output drift. Therefore, according to the vibration device 1, the angular velocity ωy can be accurately detected.

Here, as in the embodiment, the voltage V4 applied to the conductor layer 8 is most preferably the same as the voltage V1 applied to the movable portion 400. However, for example, when the potential of the voltage V1 is set to E1 (V) and the potential of the voltage V4 is set to E2 (V), any configuration may be adopted as long as a relationship of |E1−E2|<|E1| is satisfied. In this manner, it is possible to minimize the output drift, at least compared to a configuration in which the conductor layer 8 is connected to GND (0 V). However, even in this range, it is preferable that a relationship of |E1−E2|<0.5|E1| is satisfied, and more preferable that a relationship of |E1−E2|<0.2|E1| is satisfied. It is much more preferable that a relationship E1=E2 is satisfied as in the embodiment. In this manner, the output drift can be more effectively suppressed.

As described above, the conductor layer 8 is disposed on the entire lower surface of the substrate 2. Therefore, the conductor layer 8 is disposed so as to overlap the element unit 4 in a plan view in the Z-axis direction. In this manner, it is possible to minimize the movement of the movable ions (Na⁺) in the region where the substrate 2 overlaps the element unit 4. Accordingly, the above-described advantageous effect (minimizing the displacement of the movable portion 400 toward the substrate 2 side) can be effectively achieved. In particular, according to the embodiment, the conductor layer 8 is disposed so as to overlap the entire region of the element unit 4 in the plan view in the Z-axis direction. That is, the conductor layer 8 is disposed so as to overlap the entire region of the movable portion 400 in a plan view in the Z-axis direction. Therefore, the above-described advantageous effect can be more effectively achieved. However, the arrangement of the conductor layer 8 is not particularly limited. The conductor layer 8 may overlap a portion of the movable portion 400 or may not overlap the movable portion 400 in the plan view in the Z-axis direction. Here, in a case where the conductor layer 8 is disposed so as to overlap a portion of the movable portion in the plan view in the Z-axis direction, it is preferable that the conductor layer 8 overlaps 40% or more of the entire region of the movable portion 400 in the plan view in the Z-axis direction, and is more preferable that the conductor layer 8 overlaps 60% or more of the entire region of the movable portion 400.

Hitherto, the vibration device 1 has been described. As described above, the vibration device 1 has the substrate 2 containing the movable ions (Na⁺), the element unit 4 having the movable portion 400 which can be displaced from the substrate 2, and the conductor layer 8 disposed on the side of the substrate 2 which is opposite to the element unit 4. When the potential of the movable portion 400 is set to E1 and the potential of the conductor layer 8 is set to E2, the relationship of |E1−E2|<|E is satisfied. In this manner, for example, compared to a configuration in which the conductor layer 8 is connected to GND, the movement of the movable ions (Na⁺) inside the substrate 2 is minimized. Therefore, compared to the configuration in which the conductor layer 8 is connected to GND, it is possible to minimize the electrostatic attraction generated between the bottom surface of the recess portion 21 and the movable portion 400, and it is possible to minimize the change in the gap between the first and second flap plates 471 and 472 and the fixed detection electrode 5 in a state where the angular velocity ωy is not applied. Therefore, according to the vibration device 1, it is possible to minimize the output drift, and it is possible to accurately detect the angular velocity ωy.

As described above, in the vibration device 1 according to the embodiment, the relationship of E1=E2 is satisfied. In this manner, the electrostatic attraction is not substantially generated between the bottom surface of the recess portion 21 and the movable portion 400. It is possible to effectively minimize the change in the gap between the first and second flap plates 471 and 472 and the fixed detection electrode 5 in a state where the angular velocity ωy is not applied. Therefore, according to the vibration device 1, it is possible to effectively minimize the output drift.

As described above, in the vibration device 1, in the plan view in the direction (Z-axis direction) in which the conductor layer 8, the substrate 2, and the element unit 4 are juxtaposed with each other, the conductor layer 8 overlaps at least a portion of the movable portion 400. In this manner, it is possible to minimize the movement of the movable ions (Na⁺) in the region where the substrate 2 overlaps the element unit 4. Accordingly, the above-described advantageous effect (minimizing the displacement of the movable portion 400 toward the substrate 2 side) can be effectively achieved.

As described above, the vibration device 1 has the fixed detection electrode 5 disposed in the substrate 2 so as to detect the displacement of the movable portion 400 with respect to the substrate 2. In this manner, as in the embodiment, the vibration device 1 can be employed as a physical quantity sensor for detecting a physical quantity such as the angular velocity.

### Second Embodiment

Next, a vibration device according to a second embodiment of the invention will be described.

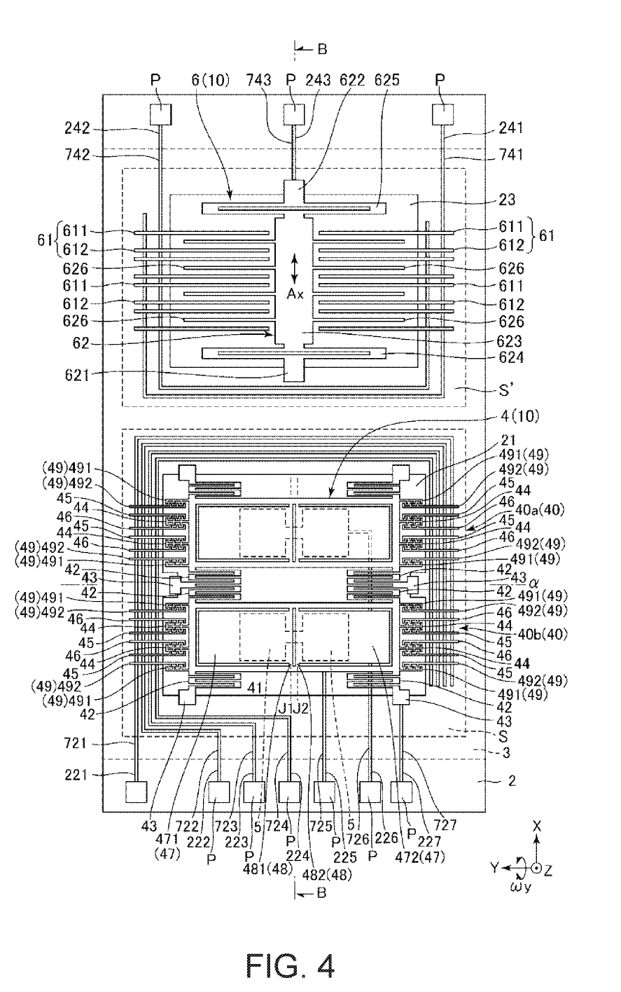

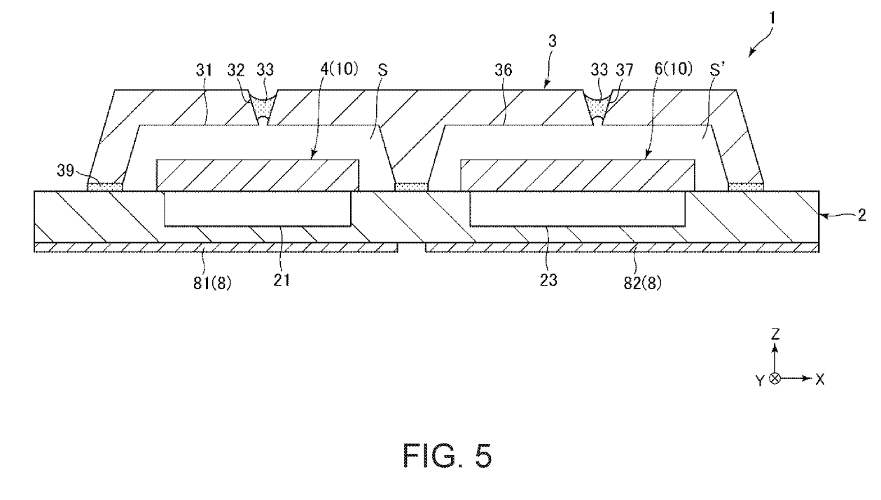

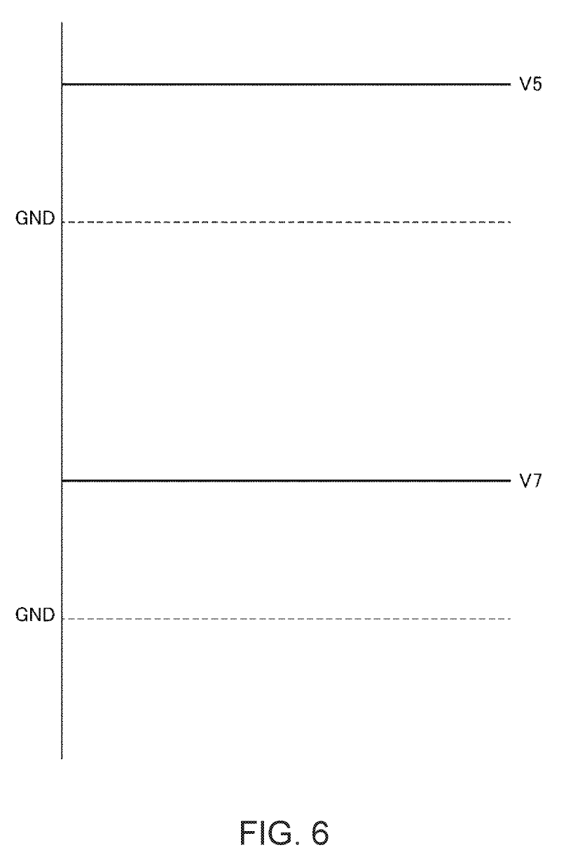

FIG. 4 is a plan view of the vibration device according to the second embodiment of the invention. FIG. 5 is a sectional view taken along line B-B in FIG. 4. FIG. 6 illustrates a voltage applied to the vibration device illustrated in FIG. 4. In FIG. 5, for the sake of convenience of description, the element units 4 and 6 are simplified and illustrated. Furthermore, the groove formed in the substrate and the wire inside the groove are omitted in the illustration.

The vibration device 1 according to the embodiment is similar to the vibration device according to the above-described first embodiment, except that the configuration of the element unit 10 and the conductor layer 8 is mainly different.

In the following description, with regard to the vibration device 1 according to the second embodiment, points different from those according to the above-described first embodiment will be mainly described, and thus, similar items will be omitted in the description. In FIGS. 4 and 5, the same reference numerals are given to the configurations the same as those according to the above-described first embodiment.

As illustrated in FIG. 4, the element unit 10 has the element unit 4 (first element unit) and the element unit 6 (second element unit). The element unit 4 is a gyrosensor capable of detecting the angular velocity ωy around the Y-axis, and has a configuration the same as that according to the above-described first embodiment. On the other hand, the element unit 6 is an acceleration sensor capable of detecting acceleration Ax in the X-axis direction. In this way, the element unit 10 has the two element units 4 and 6. Accordingly, the vibration device 1 can detect two physical quantities, and shows improved convenience. In particular, according to the embodiment, it is possible to detect two types of physical quantities (the angular velocity and the acceleration) by using the element units 4 and 6. Therefore, the convenience is further improved.

Similar to the above-described first embodiment, the substrate 2 has the recess portion 21 and the grooves 221, 222, 223, 224, 225, 226, and 227. The substrate 2 further has a recess portion 23 and grooves 241, 242, and 243. The recess portion 23 functions as an escape portion for preventing (minimizing) contact between the element unit 6 and the substrate 2. The grooves 241, 242, and 243 respectively have wires 741, 742, and 743.

As illustrated in FIG. 5, the lid body 3 has recess portions 31 and 36 which are open on the lower surface side (substrate 2 side). This lid body 3 is bonded to the upper surface of the substrate 2 so that the element unit 4 is accommodated inside the recess portion 31 and the element unit 6 is accommodated inside the recess portion 36. An accommodation space S for accommodating the element unit 4 and an accommodation space S′ for accommodating the element unit 6 are internally formed by the lid body 3 and the substrate 2.

As illustrated in FIG. 5, the lid body 3 has a communication hole 32 which allows the inside and the outside of the accommodation space S to communicate with each other and a communication hole 37 which allows the inside and the outside of the accommodation space S′ to communicate with each other. Therefore, the accommodation space S can be provided with a desired atmosphere via the communication hole 32, and the accommodation space S′ can be provided with a desired atmosphere via the communication hole 37. Sealing members 33 are respectively disposed in the communication holes 32 and 37, and the communication holes 32 and 37 are hermetically sealed with the sealing members 33. The accommodation space S is preferably in a reduced pressure state, preferably in a vacuum state. In this manner, viscous resistance decreases and the element unit 4 can be efficiently vibrated (driven). On the other hand, the accommodation space S′ is preferably filled with inert gas such as nitrogen, helium, and argon, and has atmospheric pressure at operating temperature (approximately −40° C. to +120° C.). Since the accommodation space S′ is set to have the atmospheric pressure, the viscous resistance increases. Accordingly, a damping effect is achieved, and the vibration of the element unit 6 can be promptly converged. Therefore, the accuracy in detecting the acceleration Ax of the vibration device 1 is improved. However, the atmosphere of the accommodation spaces S and S are not particularly limited.

As illustrated in FIG. 4, the element unit 6 has a fixed electrode 61 fixed to the substrate 2 and a movable portion 62 which can be displaced from the substrate 2. Similar to the element unit 4, this element unit 6 can be formed by patterning a silicon substrate doped with impurities such as phosphorus (P) and boron (B).

The movable portion 62 includes a pair of support portions 621 and 622, a base portion 623, a pair of connection portions 624 and 625, and a movable electrode finger 626. The support portions 621 and 622 are disposed so as to face the X-axis direction via the recess portion 23, and are respectively bonded to the upper surface of the substrate 2. The support portion 622 is electrically connected to the wire 743 via a conductive bump (conductive member) (not illustrated).

A base portion 623 (mass portion) is located between the support portions 621 and 622. In an end portion on the negative side in the X-axis direction, the movable portion 62 is connected to the support portion 621 via the connection portion 624. In an end on the positive side in the X-axis direction, the movable portion 62 is connected to the support portion 622 via the connection portion 625. The connection portions 624 and 625 are respectively and elastically deformable in the X-axis direction. If the acceleration Ax is applied, while the base portion 623 elastically deforms the connection portions 624 and 625, the base portion 623 is displaced from the support portions 621, 622 in the X-axis direction. The base portion 623 configured in this way is provided with a plurality of movable electrode fingers 626 which extend to both sides in the Y-axis direction and are juxtaposed with each other at an interval in the X-axis direction.

The fixed electrode 61 has a plurality of first fixed electrode fingers 611 and a plurality of second fixed electrode fingers 612. The plurality of first fixed electrode fingers 611 are disposed on the positive side in the X-axis direction of the respective movable electrode fingers 626, and are juxtaposed with each other so as to form a comb-tooth shape in which the plurality of first fixed electrode fingers 611 mesh with the corresponding movable electrode fingers 626 at an interval. On the other hand, the plurality of second fixed electrode fingers 612 are disposed on the negative side in the X-axis direction of the respective movable electrode fingers 626, and are juxtaposed with each other so as to form a comb-tooth shape in which the plurality of second fixed electrode fingers 612 mesh with the corresponding movable electrode fingers 626 at an interval. The first fixed electrode finger 611 and the second fixed electrode finger 612 are respectively bonded to the upper surface of the substrate 2 in base end portions thereof.

The respective first fixed electrode fingers 611 are electrically connected to the wire 741 via a conductive bump (not illustrated). The respective second fixed electrode fingers 612 are electrically connected to the wire 742 through a conductive bump (not illustrated).

Next, an operation of the element unit 6 will be described. For example, when the vibration device 1 is operated, a voltage V5 in FIG. 6 is applied to the movable portion 62. The first fixed electrode finger 611 and the second fixed electrode finger 612 are respectively connected to AGND. Therefore, capacitance is formed between the movable electrode finger 626 and the first and second fixed electrode fingers 611 and 612. If the acceleration Ax in the X-axis direction is applied to the vibration device 1, based on a magnitude of the acceleration Ax, while the base portion 623 elastically deforms the connection portions 624 and 625, the base portion 623 is displaced in the X-axis direction. Due to this displacement, a gap between the movable electrode finger 626 and the first fixed electrode finger 611 and a gap between the movable electrode finger 626 and the second fixed electrode finger 612 are respectively changed. In accordance with the changed amount, the capacitance between the movable electrode finger 626 and the first fixed electrode finger 611 and the capacitance between the movable electrode finger 626 and the second fixed electrode finger 612 are respectively changed. A detection signal (electrical signal) based on the change in the capacitance is output from the first and second fixed electrode fingers 611 and 612. The acceleration Ax can be detected, based on the detection signal (electrical signal).

As illustrated in FIG. 5, the conductor layer 8 has a first conductor layer 81 and a second conductor layer 82. The first conductor layer 81 is disposed so as to overlap the entire region of the element unit 4 in a plan view in the Z-axis direction, and the second conductor layer 82 is disposed so as to overlap the entire region of the element unit 6 in a plan view in the Z-axis direction. That is, the first conductor layer 81 is disposed so as to overlap the entire region of the movable portion 400 in the plan view in the Z-axis direction, and the second conductor layer 82 is disposed so as to overlap the entire region of the movable portion 62 in the plan view in the Z-axis direction. However, the arrangement of the first conductor layer 81 is not particularly limited. The first conductor layer 81 may be disposed so as to overlap a portion of the movable portion 400 in the plan view in the Z-axis direction, and may be disposed without overlapping the movable portion 400. The arrangement of the second conductor layer 82 is not particularly limited. The second conductor layer 82 may be disposed so as to overlap a portion of the movable portion 62 in the plan view in the Z-axis direction, and may be disposed without overlapping the movable portion 62. In this way, the arrangement of the first and second conductor layers 81 and 82 is not particularly limited. However, the first conductor layer 81 is preferably disposed so as not to overlap the element unit 6 in the plan view in the Z-axis direction. The second conductor layer 82 is preferably disposed so as not to overlap the element unit 4 in the plan view in the Z-axis direction.

Here, in a case where the first conductor layer 81 is disposed so as to overlap a portion of the movable portion 400 in the plan view in the Z-axis direction, it is preferable that the first conductor layer 81 overlaps 40% or more of the entire region of the movable portion 400 in the plan view in the Z-axis direction, and is more preferable that the first conductor layer 81 overlaps 60% or more of the entire region of the movable portion 400. In a case where the second conductor layer 82 is disposed so as to overlap a portion of the movable portion 62 in the plan view in the Z-axis direction, it is preferable that the second conductor layer 82 overlaps 40% or more of the entire region of the movable portion 62 in the plan view in the Z-axis direction, and is more preferable that the second conductor layer 82 overlaps 60% or more of the entire region of the movable portion 62.

When the vibration device 1 is operated, the voltage V4 (refer to FIG. 3) is applied to the first conductor layer 81 as described in the first embodiment. The magnitude of the voltage V4 is chronologically and substantially constant. Therefore, the first conductor layer 81 demonstrates a shielding effect to block or minimize leakage of a signal detected by the vibration device 1 or noise externally applied to the vibration device 1. Accordingly, the vibration device 1 can accurately detect the angular velocity ωy.

In particular, the voltage V4 is the same as the voltage V1 applied to the movable portion 400 of the element unit 4. In this manner, the first conductor layer 81 and the movable portion 400 which are disposed in the substrate 2 therebetween have the same potential. Substantially, there is no potential difference between the lower surface side and the upper surface side of the substrate 2, and the movement of the movable ions (Na⁺) inside the substrate 2 is minimized. Therefore, the charging of the bottom surface of the recess portion 21 is minimized. Therefore, it is possible to minimize the change in the gap between the first and second flap plates 471 and 472 and the fixed detection electrode 5 in a state where the angular velocity ωy is not applied, and it is possible to minimize the output drift. Therefore, according to the vibration device 1, the angular velocity ωy can be accurately detected.

Here, as in the embodiment, it is most preferable that the voltage V4 applied to the first conductor layer 81 is the same as the voltage V1 applied to the movable portion 400. However, for example, when the potential of the voltage V1 is set to E1′ (V) and the potential of the voltage V4 is set to E2′ (V), any configuration may be adopted as long as a relationship of |E1′−E2′|<|E1′| is satisfied. In this manner, it is possible to minimize the output drift, at least compared to a configuration in which the first conductor layer 81 is connected to GND (0 V). However, even in this range, it is preferable that a relationship of |E1′−E2′|<0.5|E1′| is satisfied, and more preferable that a relationship of |E1′−E2′|<0.2| E1′| is satisfied. It is much more preferable that a relationship E1′=E2′ is satisfied as in the embodiment. In this manner, the output drift can be more effectively minimized.

When the vibration device 1 is operated, a voltage V7 in FIG. 6 is applied to the second conductor layer 82. The magnitude of the voltage V7 is chronologically and substantially constant. Therefore, the second conductor layer 82 demonstrates a shielding effect to block or minimize leakage of a signal detected by the vibration device 1 or noise externally applied to the vibration device 1. Accordingly, the vibration device 1 can accurately detect the acceleration Ax.

In particular, according to the embodiment, the voltage V7 is the same as the voltage V5 applied to the movable portion 62. That is, the voltages V5 and V7 have the same magnitude. In this manner, the second conductor layer 82 and the movable portion 62 which are disposed in the substrate 2 therebetween have the same potential. Substantially, there is no potential difference between the lower surface side and the upper surface side of the substrate 2 (An electric field in the thickness direction does not act on the substrate 2), and the movement of the movable ions (Na⁺) inside the substrate 2 is minimized. Therefore, the charging of the bottom surface of the recess portion 23 is minimized. Therefore, it is possible to minimize possibilities that the movable portion 62 may be displaced to the negative side in the Z-axis direction so as to be attracted to the bottom surface side of the recess portion 23.

For example, the voltage V5 applied to the movable portion 62 is not particularly limited. The voltage may form a rectangular wave whose magnitude (potential) is periodically changed around a reference potential (that is, a voltage whose average potential is the reference potential). In this case, for example, as the voltage V7, it is possible to use a voltage whose potential is the reference potential and constant.

If the movable portion 62 is displaced to the negative side in the Z-axis direction, an area where the respective movable electrode fingers 626 face the corresponding first and second fixed electrode fingers 611 and 612 (that is, the capacitance therebetween) is changed, thereby causing the output drift to occur. Therefore, as in the embodiment, the output drift can be suppressed by minimizing the displacement of the movable portion 62 to the negative side in the Z-axis direction. Therefore, according to the vibration device 1, the acceleration Ax can be accurately detected.

Here, as in the embodiment, it is most preferable that the voltage V7 applied to the second conductor layer 82 is the same as the voltage V5 applied to the movable portion 62. However, for example, when the potential of the voltage V5 is set to E1″ (V) and the potential of the voltage V7 is set to E2″ (V), any configuration may be adopted as long as a relationship of |E1″−E2″|<|E1″| is satisfied. In this manner, it is possible to minimize the output drift, at least compared to a configuration in which the second conductor layer 82 is connected to GND (0 V). However, even in this range, it is preferable that a relationship of |E1″−E2″|<0.5|E1″| is satisfied, and more preferable that a relationship of |E1″−E2″|<0.2|E1″| is satisfied. It is much more preferable that a relationship E1″=E2″ is satisfied as in the embodiment. In this manner, the output drift can be more effectively minimized.

Hitherto, the vibration device 1 according to the embodiment has been described. The vibration device 1 according to the embodiment has the substrate 2 containing the movable ions (Na⁺), the element unit 10 having the movable portion 400 (first movable portion) and the movable portion 62 (second movable portion) which can be displaced from the substrate 2, and the conductor layer 8 disposed on the side of the substrate 2 which is opposite to the element unit 10. In a plan view in a direction (Z-axis direction) where the conductor layer 8, the substrate 2, and the element unit 10 are juxtaposed with each other, the conductor layer 8 has the first conductor layer 81 disposed so as to overlap at least a portion of the movable portion 400, and the second conductor layer 82 disposed so as to overlap at least a portion of the movable portion 62. According to the vibration device 1, when the potential of the movable portion 400 is set to E1′ and the potential of the first conductor layer 81 is set to E2′, the relationship of |E1′−E2′|<|E1′| is satisfied. When the potential of the movable portion 62 is set to E1″ and the potential of the second conductor layer 82 is set to E2″, the relationship of |E1″−E2″|<|E1″| is satisfied. In this manner, for example, compared to a configuration in which the first and second conductor layers 81 and 82 are connected to GND, it is possible to minimize the movement of the movable ions (Na⁺) inside the substrate 2. Therefore, compared to the configuration in which the first and second conductor layers 81 and 82 are connected to GND, it is possible to minimize the electrostatic attraction generated between the bottom surface of the recess portion 21 and the movable portion 400 and the electrostatic attraction generated between the bottom surface of the recess portion 23 and the movable portion 62. It is possible to minimize the change in the capacitance between the first and second flap plates 471 and 472 and the fixed detection electrode 5 in a state where the angular velocity ωy is not applied, and the change in the capacitance between the movable electrode finger 626 and the second fixed electrode fingers 611 and 612 in a state where the acceleration Ax is not applied. Therefore, according to the vibration device 1, it is possible to minimize the output drift, and the angular velocity ωy and the acceleration Ax can be respectively and accurately detected.

As described above, in the vibration device 1 according to the embodiment, the element unit 10 can detect the angular velocity ωy in the first movable portion 400 (first movable portion) and can detect the acceleration Ax in the movable portion 62 (second movable portion). In this manner, the vibration device 1 can be used as a composite sensor which can detect the acceleration and the angular velocity. Therefore, the convenience of the vibration device 1 is improved.

According to the second embodiment configured in this way, advantageous effects the same as those according to the above-described first embodiment can also be achieved.

### Third Embodiment

Next, a vibration device module according to a third embodiment of the invention will be described.

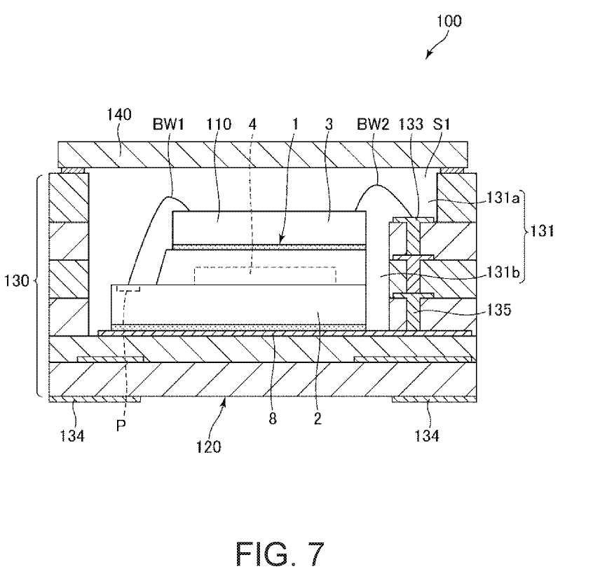

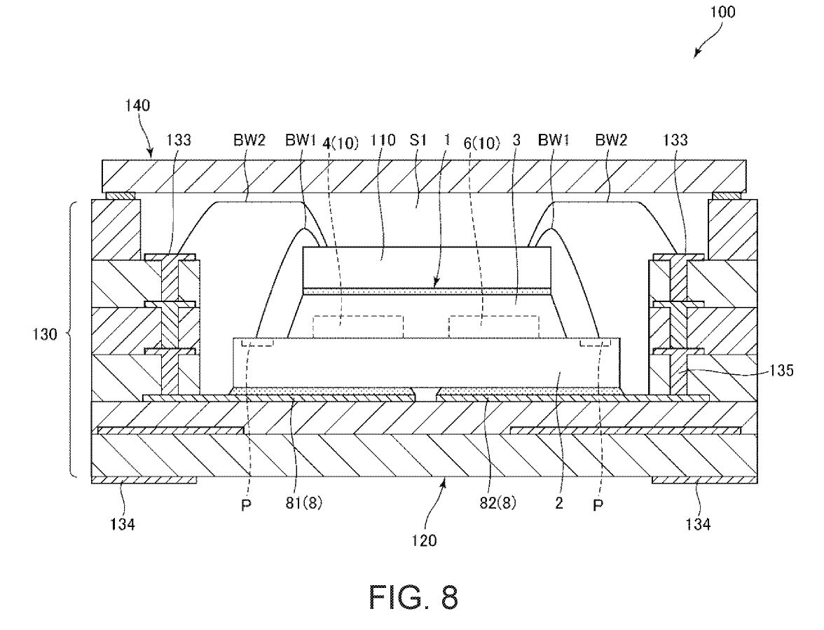

FIG. 7 is a sectional view illustrating the vibration device module according to the third embodiment of the invention. FIG. 8 is a sectional view illustrating a modification example of the vibration device module illustrated in FIG. 7.

As illustrated in FIG. 7, a vibration device module 100 has the vibration device 1, a circuit element 110, and a package 120 which accommodates the vibration device 1 and the circuit element 110. The vibration device 1 is not particularly limited. For example, as the vibration device 1, it is possible to use those which adopt the configuration according to the above-described respective embodiments.

As illustrated in FIG. 7, the circuit element 110 (IC) is bonded to the lid body 3 of the vibration device 1 via a bonding member. The circuit element 110 is electrically connected to each electrode pad P of the vibration device 1 via a bonding wire BW1, and is electrically connected to the package 120 (internal layer 133 to be described later) via a bonding wire BW2. If necessary, this circuit element 110 includes a drive circuit for driving the vibration device 1, a detection circuit for detecting the angular velocity, based on an output signal from the vibration device 1, and an output circuit for converting a signal from the detection circuit into a predetermined signal and outputting the predetermined signal. The circuit element 110 may be disposed outside the package 120 or may be omitted.

As illustrated in FIG. 7, the package 120 has a base 130 and a lid body 140 bonded to the upper surface of the base 130 so as to form an accommodation space S1 for accommodating the vibration device 1 and the circuit element 110 between the base 130 and the lid body 140.

The base 130 has a cavity shape having a recess portion 131 which is open on the upper surface. The recess portion 131 has a first recess portion 131a which is open on the upper surface of the base 130 and a second recess portion 131b which is open on the bottom surface of the first recess portion 131a.

On the other hand, the lid body 140 has a plate shape, and is bonded to the upper surface of the base 130 so as to close the opening of the recess portion 131. In this way, the opening of the recess portion 131 is closed using the lid body 140, thereby forming the accommodation space S1 and allowing the accommodation space S1 to accommodate the vibration device 1 and the circuit element 110.

The accommodation space S1 is hermetically sealed, and has the atmosphere the same as that of the accommodation space S of the vibration device 1. That is, according to the embodiment, it is preferable that the accommodation space S1 is in a vacuum state. In this manner, even if the airtightness of the accommodation space S collapses and the accommodation space S and the accommodation space S1 communicate with each other, the atmosphere of the accommodation space S can be maintained without any change. Therefore, it is possible to minimize possibilities that the angular velocity detection characteristics of the vibration device 1 may be changed due to the change in the atmosphere of the accommodation space S. Accordingly, the vibration device module 100 can be stably driven. The description of “the same atmosphere” is not limited to a case where both of these are perfectly coincident with each other, and the meaning includes a case where there is an inevitable error in manufacturing, such as slightly different pressure inside both spaces. The atmosphere of the accommodation space S1 may not be the same as that of the accommodation space S.

A configuration material of the base 130 is not particularly limited. For example, it is possible to use various ceramics such as oxide ceramics of alumina, silica, titania, and zirconia, or nitride ceramics of silicon nitride, aluminum nitride, and titanium nitride. In this case, the base 130 can be manufactured by firing a stacked body of ceramic sheets (green sheets). According to this configuration, the recess portion 131 can be easily formed. In the embodiment, the base 130 is formed of the stacked body of six ceramic sheets.

A configuration material of the lid body 140 is not particularly limited, and may be a member having a linear expansion coefficient close to that of the configuration material of the base 130. For example, in a case where the configuration material of the base 130 is ceramics as described above, it is preferable to use an alloy such as kovar.

As illustrated in FIG. 7, the base 130 has a plurality of internal layers 133 disposed on the bottom surface of the first recess portion 131a, the conductor layer 8 disposed on the bottom surface of the second recess portion 131b, and a plurality of external layers 134 disposed on the lower surface. Each of the internal layers 133 is electrically connected to the predetermined external layer 134 and the conductor layer 8 via an internal wire 135 disposed inside the base 130. The plurality of internal layers 133 are respectively and electrically connected to the circuit element 110 via the bonding wire BW2. In this manner, the plurality of internal layers 133 can be electrically connected to the circuit element 110 from the outside of the package 120. Accordingly, the vibration device module 100 can be easily mounted.

As described above, the conductor layer 8 is disposed in the base 130, and is omitted from the vibration device 1. In the vibration device 1, the substrate 2 is bonded to the conductor layer 8 via an insulating bonding member so as to face the conductor layer 8 side. In this way, the conductor layer 8 is disposed in the base 130. Accordingly, the conductor layer 8 and the circuit element 110 can easily be electrically connected to each other via the internal wire 135. However, the conductor layer 8 may be disposed on the lower surface of the substrate 2 as in the above-described first embodiment.

Hitherto, the vibration device module 100 has been described. As described above, this vibration device module 100 has the vibration device 1 and the package 120 for accommodating the vibration device 1. Therefore, the vibration device 1 can be effectively protected. It is possible to obtain the advantageous effect of the vibration device 1 described above, and it is possible to obtain the very reliable vibration device module 100.

The vibration device module 100 has the circuit element 110 accommodated in the package 120 and electrically connected to the vibration device 1. In this manner, the circuit element 110 can be protected by the package 120.

A configuration of the vibration device module 100 is not particularly limited. For example, as illustrated in FIG. 8, the vibration device 1 according to the above-described second embodiment may be used as the vibration device 1.

### Fourth Embodiment

Next, a vibration device module according to a fourth embodiment of the invention will be described.

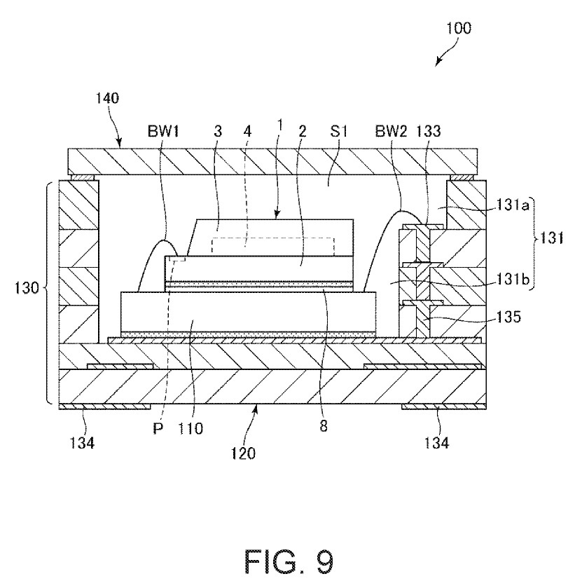

FIG. 9 is a sectional view illustrating the vibration device module according to the fourth embodiment of the invention.

The vibration device module 100 according to the embodiment is the same as the vibration device module according to the above-described third embodiment, mainly except that the vibration device 1 and the circuit element 110 are reversed in the arrangement and the conductor layer 8 is differently disposed.

In the following description, with regard to the vibration device module 100 according to the fourth embodiment, points different from those according to the above-described third embodiment will be mainly described, and thus, similar items will be omitted in the description. In FIG. 9, the same reference numerals are given to the configurations the same as those according to the above-described embodiments.

As illustrated in FIG. 9, in the vibration device module 100 according to the embodiment, the circuit element 110 is bonded to the bottom surface of the second recess portion 131b via a bonding member. The conductor layer 8 electrically connected to the circuit element 110 is disposed on the upper surface of the circuit element 110. The vibration device 1 is bonded to the upper surface of the conductor layer 8 via a bonding member. That is, the vibration device 1 is fixed to the package 120 via the circuit element 110. According to this configuration, for example, compared to the configuration according to the above-described third embodiment, internal stress of the package 120 is less likely to be transmitted to the vibration device 1. Therefore, it is possible to minimize unintended deflection of the vibration device 1, and it is possible to minimize possibilities that the angular velocity detection characteristic of the vibration device 1 may be degraded.

According to the fourth embodiment configured in this way, advantageous effects the same as those according to the above-described third embodiment can also be achieved.

### Fifth Embodiment

Next, a vibration device module according to a fifth embodiment of the invention will be described.

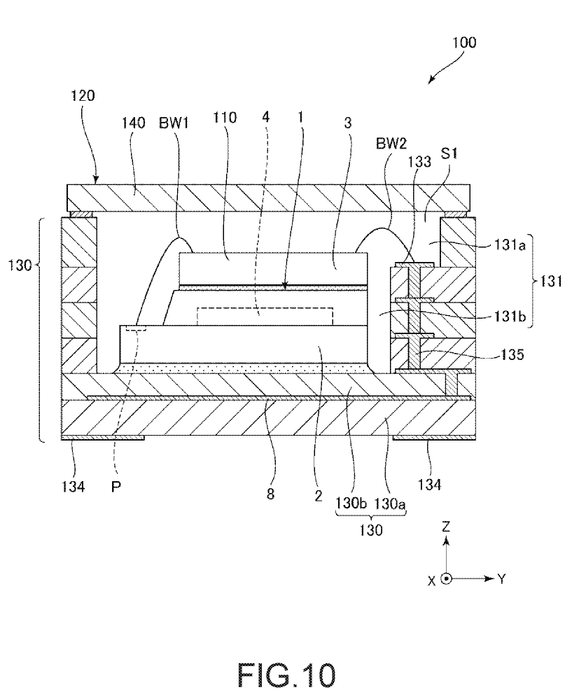

FIG. 10 is a sectional view illustrating the vibration device module according to the fifth embodiment of the invention.

The vibration device module 100 according to the embodiment is the same as the vibration device module 100 according to the third embodiment, mainly except that the conductor layer 6 is differently disposed.

In the following description, with regard to the vibration device module 100 according to the fifth embodiment, points different from those according to the above-described third embodiment will be mainly described, and thus, similar items will be omitted in the description. In FIG. 10, the same reference numerals are given to the configurations the same as those according to the above-described embodiments.

As illustrated in FIG. 10, in the vibration device module 100 according to the embodiment, the conductor layer 8 is embedded in the base 130. Specifically, the conductor layer 8 is disposed between a first insulation layer 130a and a second insulation layer 130b which configure a bottom portion of the base 130. That is, the conductor layer 8 is configured to include the internal wire 135. In this configuration, an insulation layer including the second insulation layer 130b is interposed between the substrate 2 and the conductor layer 8.

According to the fifth embodiment configured in this way, advantageous effects the same as those according to the above-described third embodiment can also be achieved.

### Sixth Embodiment

Next, an electronic device according to a sixth embodiment of the invention will be described.

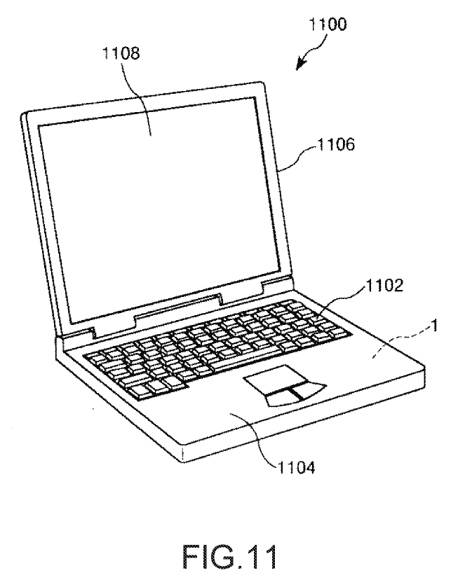

FIG. 11 is a perspective view illustrating the electronic device according to the sixth embodiment of the invention.

A mobile (or notebook) personal computer 1100 illustrated in FIG. 11 is an example to which the electronic device including the vibration device according to the invention is applied. In this drawing, the personal computer 1100 is configured to include a main body 1104 provided with a keyboard 1102, and a display unit 1106 provided with a display 1108. The display unit 1106 is supported so as to be pivotable with respect to the main body 1104 via a hinge structure portion. This personal computer 1100 is internally equipped with the vibration device 1 functioning as the angular velocity sensor. Here, for example, as the vibration device 1, any one of the above-described embodiments can be adopted.

This personal computer 1100 (electronic device) has the vibration device 1. Therefore, it is possible to obtain the advantageous effect of the vibration device 1 described above, and it is possible to achieve high reliability.

### Seventh Embodiment

Next, an electronic device according to a seventh embodiment of the invention will be described.

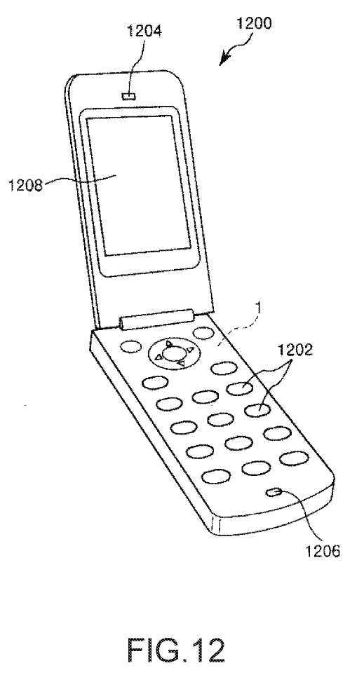

FIG. 12 is a perspective view illustrating the electronic device according to the seventh embodiment of the invention.

A mobile phone 1200 (including PHS) illustrated in FIG. 12 is an example to which the electronic device including the vibration device according to the invention is applied. In this drawing, the mobile phone 1200 includes an antenna (not illustrated), a plurality of operation buttons 1202, an earpiece 1204, and a mouthpiece 1206. A display 1208 is disposed between the operation buttons 1202 and the earpiece 1204. This mobile phone 1200 is internally equipped with the vibration device 1 functioning as the angular velocity sensor. Here, for example, as the vibration device 1, any one of the above-described embodiments can be adopted.

This mobile phone 1200 (electronic device) has the vibration device 1. Therefore, it is possible to obtain the advantageous effect of the vibration device 1 described above, and it is possible to achieve high reliability.

### Eighth Embodiment

Next, an electronic device according to an eighth embodiment of the invention will be described.

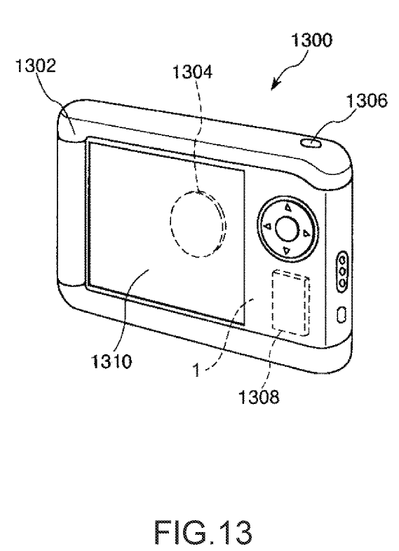

FIG. 13 is a perspective view illustrating the electronic device according to the eighth embodiment of the invention.

A digital still camera 1300 illustrated in FIG. 13 is an example to which the electronic device including the vibration device according to the invention is applied. In this drawing, a display 1310 is disposed on a rear surface of a case (body) 1302, and is configured to perform display, based on an imaging signal transmitted by a CCD. The display 1310 functions as a viewfinder which displays a subject as an electronic image. A light receiving unit 1304 including an optical lens (imaging optical system) and the CCD is disposed on a front surface side (rear surface side in the drawing) of the case 1302. If an image capturing person confirms a subject image displayed on the display 1310 and presses a shutter button 1306, the imaging signal of the CCD at that time is transmitted and stored in a memory 1308. This digital still camera 1300 is internally equipped with the vibration device 1 functioning as the angular velocity sensor. Here, for example, as the vibration device 1, any one of the above-described embodiments can be adopted.

This digital still camera 1300 (electronic device) has the vibration device 1. Therefore, it is possible to obtain the advantageous effect of the vibration device 1 described above, and it is possible to achieve high reliability.

In addition to the personal computer, the mobile phone, and the digital still camera according to the above-described embodiments, the embodiment the electronic device according to the invention, for example, the electronic device according to the invention is applicable to a smartphone, a tablet terminal, a timepiece (including a smart watch), an ink jet-type discharge device (for example, an ink jet printer), a laptop-type personal computer, a television, a wearable terminal such as a head mounted display (HMD), a video camera, a video tape recorder, a car navigation device, a pager, an electronic diary (including those which are provided with a communication function), an electronic dictionary, a calculator, an electronic game machine, a word processor, a workstation, a video phone, a video monitor for security, an electronic binocular, a POS terminal, a medical instrument (for example, an electronic clinical thermometer, a blood pressure monitor, a blood glucose meter, an electrocardiogram measuring device, an ultrasound diagnosis apparatus, and an electronic endoscope), a fish finder, various measuring instruments, devices for mobile terminals and base stations, meters (for example, instruments for vehicles, aircrafts, and ships), flight simulators, and network servers.

### Ninth Embodiment

Next, a vehicle according to a ninth embodiment of the invention will be described.

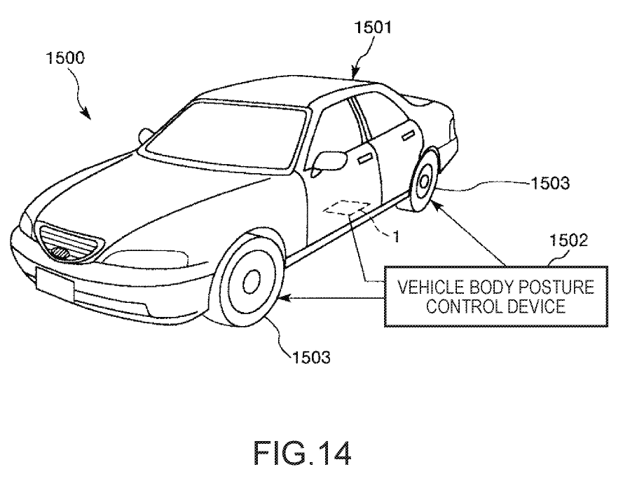

FIG. 14 is a perspective view illustrating the vehicle according to the ninth embodiment of the invention.

A vehicle 1500 illustrated in FIG. 14 is an example to which the vehicle including the vibration device according to the invention is applied. In this drawing, the vehicle 1500 is internally equipped with the vibration device 1 functioning as the angular velocity sensor. The vibration device 1 can detect a posture of a vehicle body 1501. A detection signal of the vibration device 1 is supplied to a vehicle body posture control device 1502. The vehicle body posture control device 1502 detects the posture of the vehicle body 1501, based on the signal. In accordance with a detection result, the vehicle body posture control device 1502 can control hardness/softness of a suspension, or can control a brake of each vehicle wheel 1503. Here, for example, as the vibration device 1, any one of the above-described embodiments can be adopted.

This vehicle 1500 (vehicle) has the vibration device 1. Therefore, it is possible to obtain the advantageous effect of the vibration device 1 described above, and it is possible to achieve high reliability.

Alternatively, the vibration device 1 is widely applicable to a car navigation system, a car air conditioner, an anti-lock braking system (ABS), an air bag, a tire pressure monitoring system (TPMS), an engine control, a hybrid vehicle, and an electronic control unit (ECU) such as a battery monitor for electric vehicles.

The vehicle is not limited to the vehicle 1500. For example, the vehicle is applicable to unmanned aircrafts such as an airplane, a rocket, an artificial satellite, a ship, an automated guided vehicle (AGV), a bipedal walking robot, and a drone.

Hitherto, the vibration device, the vibration device module, the electronic device, and the vehicle according to the invention have been described with reference to the illustrated embodiments. However, the invention is not limited thereto. A configuration of each unit can be replaced with any desired configuration having the same function. Any other desired configuration element may be added to the invention.

In the above-described first embodiment, a configuration has been described in which the detecting flap plate pivots around the pivot shaft. However, the detecting flap plate may be displaced in any way as long as the detecting flap plate can be displaced in the Z-axis direction. For example, the detecting flap plate may perform seesaw oscillating around the pivot shaft, or may be displaced in the Z-axis direction while the posture is maintained. That is, the vibration device may employ an oscillating type, or may employ a parallel plate type.

In the above-described first embodiment, a configuration has been described in which the angular velocity around the Y-axis is detected. However, the detection axis of the angular velocity is not particularly limited. The angular velocity around the X-axis may be detected, or the angular velocity around the Z-axis may be detected. A configuration may be adopted which has at least two of the movable portion for detecting the angular velocity around the Y-axis, the movable portion for detecting the angular velocity around the X-axis, and the movable portion for detecting the angular velocity around the Z-axis portion. That is, the number of the movable portions is not particularly limited.

In a case where the vibration device is used as a physical quantity sensor, a physical quantity detected by the vibration device is not limited to the angular velocity and the acceleration. For example, pressure may be detected. Without being limited to the physical quantity sensor, the vibration device may be a vibrator used for an oscillator and a MEMS switch.

What is claimed is:

1. A vibration device comprising:
a substrate that contains movable ions;
an element unit that is disposed so as to overlap the substrate in a plan view, and that includes a movable portion which is displaceable; and
a conductor layer that is disposed on a side of the substrate which is opposite to the element unit side,
wherein when a potential of the movable portion is set to E1 and a potential of the conductor layer is set to E2,

|E1−E2|<|E1| is satisfied.

2. The vibration device according to claim 1,
wherein E1=E2 is satisfied.

3. The vibration device according to claim 1,
wherein in a plan view obtained in a direction where the conductor layer, the substrate, and the element unit overlap one another, the conductor layer overlaps at least a portion of the movable portion.

4. A vibration device comprising:
a substrate that contains movable ions;
an element unit that is disposed so as to overlap the substrate in a plan view, and that includes a first movable portion and a second movable portion which are displaceable; and
a conductor layer that is disposed on a side of the substrate which is opposite to the element unit side,
wherein in a plan view obtained in a direction where the conductor layer, the substrate, and the element unit overlap one another, the conductor layer includes
a first conductor layer that overlaps at least a portion of the first movable portion, and
a second conductor layer that overlaps at least a portion of the second movable portion,
wherein when a potential of the first movable portion is set to E1′ and a potential of the first conductor layer is set to E2′,

|E1′−E2′|<|E1′ is satisfied, and
wherein when a potential of the second movable portion is set to E1″ and a potential of the second conductor layer is set to E2″,

|E1″−E2″|<|E1″| is satisfied.

5. The vibration device according to claim 4,
wherein the first movable portion detects angular velocity, and
wherein the second movable portion detects acceleration.

6. The vibration device according to claim 5,
wherein the substrate has a fixed detection electrode that detects displacement of the movable portion.

7. A vibration device module comprising:
the vibration device according to claim 1; and
a package that accommodates the vibration device.

8. A vibration device module comprising:
the vibration device according to claim 2; and
a package that accommodates the vibration device.

9. A vibration device module comprising:
the vibration device according to claim 3; and
a package that accommodates the vibration device.

10. A vibration device module comprising:
the vibration device according to claim 4; and
a package that accommodates the vibration device.

11. The vibration device module according to claim 7, further comprising:
a circuit element that is accommodated in the package, and that is electrically connected to the vibration device.

12. The vibration device module according to claim 11,
wherein the vibration device is attached to the package via the circuit element.

13. An electronic device comprising:
the vibration device according to claim 1.

14. An electronic device comprising:
the vibration device according to claim 2.

15. An electronic device comprising:
the vibration device according to claim 3.

16. An electronic device comprising:
the vibration device according to claim 4.

17. A vehicle comprising:
the vibration device according to claim 1.

18. A vehicle comprising:
the vibration device according to claim 2.

19. A vehicle comprising:
the vibration device according to claim 3.

20. A vehicle comprising:
the vibration device according to claim 4.
